(19) United States
(12) Patent Application Publication
(10) Pub. No.: US 2020/0025234 A1
(43) Pub. Date: Jan. 23, 2020

(54) Adhesively Bonded Damper Sleeve

(71) Applicant: Hilti Aktiengesellschaft, Schaan (LI)

(72) Inventor: Huu Toan NGUYEN, Eichberg (CH)

(73) Assignee: Hilti Aktiengesellschaft, Schaan (LI)

(21) Appl. No.: 16/500,001

(22) PCT Filed: Mar. 28, 2018
(86) PCT No.: PCT/EP2018/057581

§ 371 Date: Oct. 1, 2019

(30) Foreign Application Priority Data
Apr. 6, 2017 (EP) 17165154.0

(51) Int. Cl. F16B 13/14; B05C 5/02

(52) U.S. Cl. CPC F16B 13/144; B05C 5/0212

(57) ABSTRACT

A method for installing an anchor for the fastening of an attachment part to a base part includes arranging an anchor bolt of the anchor in a hole which is provided in the base part and in a through hole provided in the attachment part. A damper sleeve is arranged on the anchor bolt such that the damper sleeve surrounds the anchor bolt. The damper sleeve is adhesively bonded to the attachment part by adhesive.

### CROSS REFERENCE TO RELATED APPLICATIONS

This application claims the priority of International Application No. PCT/EP2018/057581, filed Mar. 26, 2018, and European Patent Document No. 17165154.0, filed Apr. 6, 2017, the disclosures of which are expressly incorporated by reference herein.

### BACKGROUND AND SUMMARY OF THE INVENTION

The invention relates to a method for installing an anchor for the fastening of an attachment part to a base part, in which method an anchor bolt of the anchor is arranged in a hole which is provided in the base part and in a through hole provided in the attachment part, and a damper sleeve is arranged on the anchor bolt such that the damper sleeve surrounds the anchor bolt. The invention also relates to a unit, in particular for use in a method of the type, having a damper sleeve and having at least one adhesive reservoir fixed to the damper sleeve, which adhesive reservoir contains adhesive.

From DE102008063580 A1, damper sleeves for anchor bolts with elastomer elements are known, which are inserted into the attachment part to be fastened and which are meant to dampen shock-like lateral forces, which may occur in the case of earthquakes, for example. Further damper sleeves are known from DE102007032313 A1, wherein these damper sleeves have elements for a plastic deformation in addition to the elastomer elements.

It is further known to fill the annular gap that is formed around the anchor bolt of an anchor that is anchored in a hole with a curable mass. The anchor can hereby be radially supported, which can improve the load values, in particular in the case of a dynamic load and/or a cyclical load in the ruptured concrete. According to DE10204591 A1, the filling of the annular gap occurs from the middle of the hole, namely through a filling channel formed in the anchor bolt. According to DE10111470 A1, the curable mass is injected from the outside into the hole through a special washer. According to the European patent application with the application record number 16150747.0, the curable mass is provided on an extrusion washer through which the anchor bolt of the anchor is inserted. The curable mass is then extruded between the extrusion washer and the attachment part through tightening of the anchor nut on the anchor.

US20060110238 A1 describes a system with an elastic body that re-tensions, whereby a loosening of screws is meant to be prevented.

The object of the invention is to provide a method for installing an anchor and a unit, in particular for use in a method of the type, which allow particularly good anchor performances with particularly high user friendliness and reliability.

A method according to the invention is characterized in that the damper sleeve is adhesively bonded to the attachment part by means of adhesive. The damper sleeve is thus fixed to the attachment part.

A basic concept of the invention can be considered the adhesive bonding of the damper sleeve to the attachment part at least directly or indirectly, in particular by means of adhesive, which is supplied in a unit with the damper sleeve. Surprisingly, it has been shown that loading an attachment part may lead to a radial slipping of the damper sleeve on the attachment part, which can in turn undesirably influence the performance of the damper sleeve and thus of the anchor. By means of the adhesive bonding provided according to the invention, this slipping can be prevented such that a particularly well-performing anchor can be achieved. At the same time, the installation by means of adhesive bonding as provided according to the invention can be performed in a particularly simple manner. Thus, by contrast to damper sleeves that are arranged in a countersunk manner, it is not necessary, for example, to provide the attachment part with a receiving bore hole for the damper sleeve. Further, by contrast to damper sleeves that are arranged in a countersunk manner, a simple installation is also possible according to the invention when the anchor bolt is not arranged exactly coaxially in the through hole in the attachment part. The invention is thus particularly suitable for such arrangements in which one and the same attachment part is fixed with multiple anchors. Namely, in the case of multiple anchors, the coaxiality of an anchor bolt normally cannot be produced simply by sliding the attachment part, because this sliding usually results in the loss of the coaxiality of the other anchor bolt. If the adhesive used for the adhesive bonding is also supplied in a unit along with the damper sleeve according to the invention, then the installation can be even further simplified, because no additional adhesive container must be provided.

The damper sleeve is advantageously provided in order to dissipate kinetic energy, in particular kinetic energy of a radial motion of the anchor bolt, that is to say to convert it into thermal energy. The damper sleeve preferably has at least one element consisting of elastomer, for example rubber, in particular an elastomer sleeve consisting of elastomer, which is arranged around the anchor bolt.

A conventional understanding of an adhesive bonding procedure is, in particular, the production of a connection through surface adhesion and internal rigidity of the adhesive.

The adhesive can be introduced, for example, by means of an adhesive dispenser between the damper sleeve and the attachment part. However, it is particularly preferred for at least one adhesive reservoir to be pressed between the damper sleeve and the attachment part, whereby adhesive is extruded from the at least one adhesive reservoir, by means of which the damper sleeve is adhesively bonded to the attachment part. Accordingly, the adhesive can, as it were, be automatically released during the installation method, which can even further improve the user-friendliness and reliability.

Advantageously, a unit can be provided having the damper sleeve and the at least one adhesive reservoir and in which the adhesive reservoir is fixed to the damper sleeve, and the unit can be fitted upon the anchor bolt. According to this embodiment, the adhesive reservoir with the adhesive and the damper sleeve form a container, and the adhesive is particularly simply and reliably brought to the provided adhesive bonding site upon mounting of the damper sleeve on the anchor, which can even further simplify the method and even further increase the reliability. In particular, a system is given which can be fitted simply onto the anchor. The proposed method is distinguished by its simplicity, because the unit consisting of the damper sleeve, adhesive reservoir with adhesive, and preferably also an extrusion washer and/or mixing element can be mounted in a single procedure.

A further preferred embodiment of the invention lies in that adhesive, in particular from the adhesive reservoir, is introduced into the through hole and into the hole, respectively, for the at least partial filling of the through hole in the attachment part and preferably also the at least partial filling of the hole in the base part, respectively. According to this embodiment, the gap between the anchor bolt and the attachment part, preferably as well as between the anchor bolt and the base part, is also filled with the same adhesive quantity that is used for the fixing of the damper sleeve on the attachment part. The advantages of the filling and the damper sleeve can hereby be combined in a particularly simple manner.

A unit according to the invention can be provided, in particular, for use in a method according to the invention. It has a damper sleeve and at least one, in particular intact, adhesive reservoir fixed on the damper sleeve, which contains adhesive. Additionally, the unit can have, for example, an extrusion washer with mixing elements, which is arranged between the adhesive reservoir and the damper sleeve. The damper sleeve can be connected to the adhesive reservoir or the extrusion washer in the unit, for example by means of adhesive bonding and/or vulcanization. In particular, the unit can have a device as described in the European patent application with the application record number 16150747.0.

The invention also relates to a fastening set consisting of a unit according to the invention and an anchor with an anchor bolt, wherein the damper sleeve of the unit is configured for receiving and damping the anchor bolt, that is to say the unit in combination with the associated anchor.

Features that are explained in connection with the method according to the invention can also be used in the unit according to the invention and the fastening arrangement according to the invention; conversely, features that are explained in connection with the unit according to the invention or the fastening arrangement according to the invention can also be used in the method according to the invention.

In the following, the invention will be explained in further detail by way of preferred exemplary embodiments, which are shown schematically in the attached figures, wherein individual features of the exemplary embodiments within the scope of the invention as shown in the following can be realized individually or in any desired combination.

### BRIEF DESCRIPTION OF THE DRAWINGS

FIGS. 1 and 2 illustrate sequential stages in the performance of an exemplary embodiment of the method according to the invention, wherein the elements used are shown in a longitudinal cross-section;

FIG. 3 is a rough schematic view of a unit, in particular for use in a method according to FIGS. 1 and 2; and

FIGS. 4 and 5 illustrate a possible detail configuration of the unit from FIG. 3 in FIG. 4 from below without showing the sealing washer and in FIG. 5 in a longitudinal cross-section (A-A in FIG. 4)

### DETAILED DESCRIPTION OF THE DRAWINGS

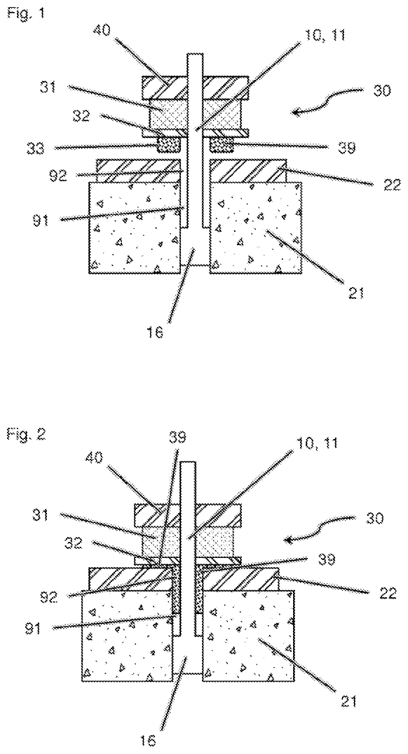

FIGS. 1 and 2 show sequential stages in the performance of a method according to the invention for installing an anchor 10, which is provided for the fastening of an attachment part 22 to a base part 21.

The attachment part 22 and the base part 21 are positioned with respect to one another such that a through hole 92 provided in the attachment part 22 overlaps a hole 91 provided in the base part 21, and an anchor bolt 11 of the anchor 10 is arranged in the overlapping holes 91 and 92. The anchor 10 has an anchor area 16 in the front region of the anchor bolt 11, which is provided for the anchoring of the anchor 10 in the hole 91 of the base part 21. With an anchor 10 embodied as an expansion anchor, for example, the anchor area 16 can be an expansion area, which converts tensile forces in the anchor bolt 11 into radial expansion forces. The rear region of the anchor bolt 11 projects from the attachment part 22 on the back side of the attachment part 22 facing away from the base part 21.

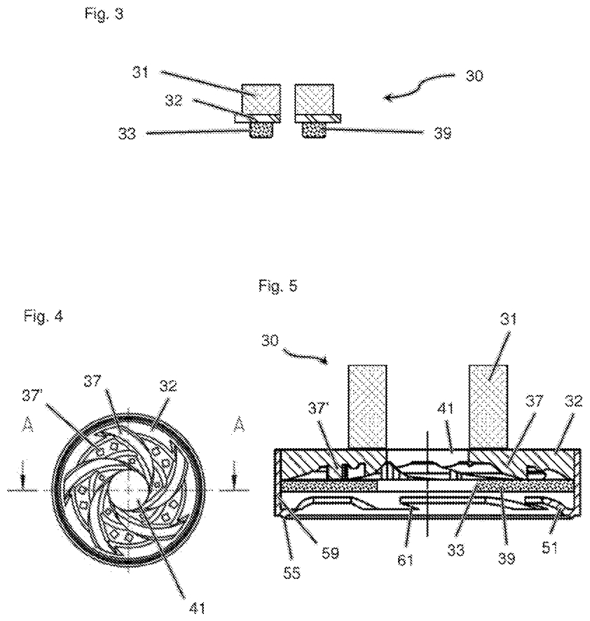

In the first method step shown in FIG. 1, the unit 30 shown in FIG. 3 is fitted onto the rear region of the anchor bolt 11. The unit 30 has a damper sleeve 31, at least one adhesive reservoir 33 fastened to the damper sleeve 31 and containing adhesive 39, and an extrusion washer 32 for the extrusion of the adhesive 39 from the adhesive reservoir 33.

The damper sleeve 31 is fastened rearwards to the extrusion washer 32, and the adhesive reservoir 33 is fastened frontwards to the extrusion washer 32. The adhesive reservoir 33 is thus directly fastened to the damper sleeve, namely through the extrusion washer 32. Preferably, the damper sleeve 31 can be materially connected to the extrusion washer 32, and, for example, the damper sleeve 31 can be vulcanized onto the extrusion washer 32.

In principle, other embodiments of the unit 30 are conceivable for the method, in particular including those without an extrusion washer 32, in which the adhesive reservoir 33 is directly fastened to the damper sleeve 31, or those with additional elements between the damper sleeve 31 and the adhesive reservoir 33. In the method according to the invention, embodiments are also conceivable in which the damper sleeve 31, the adhesive reservoir 33, and the extrusion washer 32 (if present) do not form a unit 30, but rather in which these elements are first brought into contact with one another at the anchor bolt 11.

Upon fitting the unit 30 onto the anchor bolt 11, the anchor bolt 11 is inserted into the damper sleeve 31, preferably through the extrusion washer 32, such that the damper sleeve 31 surrounds the anchor bolt 11 in an annular manner. After the fitting, the adhesive reservoir 33 of the damper sleeve 31 is moved upstream and it thus located between the attachment part 22 and the damper sleeve 31. An anchor nut 40 is then screwed onto the anchor bolt 11, such that the unit 30 is located between the anchor nut 40 and the attachment part 22. The resulting state is shown in FIG. 1.

The unit 30 is then pressed onto the attachment part 22, preferably by means of tightening the anchor nut 40, and the adhesive reservoir 33 is hereby squeezed between the damper sleeve 31 with the extrusion washer 32 on one side and the attachment part 22 on the other side. The adhesive 39 exits the adhesive reservoir 33 and produces a direct adhesive bonding between the extrusion washer 32 and the attachment part 22 and thus an indirect adhesive bonding between the damper sleeve 31 and the attachment part 22. Due to this adhesive bonding, the damper sleeve 31 is now fixed onto the attachment part 22 and cannot slip, in particular radially, on the attachment part 22. The resulting state is shown in FIG. 2. Because the extrusion washer 32 acts as a plunger on the adhesive reservoir 33, the extrusion washer 32 can also be referred to as the plunger washer.

As shown in FIG. 2, it can also be provided that adhesive 39 travels, preferably through extrusion of the adhesive reservoir 33, from the adhesive reservoir 33 into the through hole 92 in the attachment part 22 and preferably also into the hole 91 in the base part 21, where the adhesive 39 can fill the annular gap that surrounds the anchor bolt 11. This can even further improve the lateral force behavior.

FIGS. 4 and 5 show a possible detail embodiment of the unit 30 from FIG. 3. As shown in FIGS. 4 and 5, the extrusion washer 32 has a through opening 41 for the anchor bolt 11. Positioned upstream from the extrusion washer 32 is the adhesive reservoir 33, which can be, for example, a foil pouch and can contain a quantity of adhesive 39. The adhesive reservoir 33 is formed in an annular manner, for example, and surrounds the anchor bolt 11. Positioned upstream from the adhesive reservoir 33 is a sealing washer 51, which similarly has a through opening 61 for the anchor bolt 11. The adhesive reservoir 33 is thus located between the extrusion washer 32 and the sealing washer 51, wherein the unit 30 is arranged during installation such that the extrusion washer 32 faces the anchor nut 40 and the sealing washer 51 faces the base part 21 and the attachment part 22. On its front side facing away from the extrusion washer 32 and the adhesive reservoir 33, the sealing washer 51 has a sealing lip 55 for the attachment part 22, and on its back side facing the extrusion washer 32 it has a sealing sleeve 59, in which the extrusion washer 32 is slidably arranged and which radially seals the reservoir 33. The extrusion washer 32 has mixing bodies 37 and 37′, which project from the extrusion washer 32 into the adhesive reservoir 33. The mixing bodies 37 are pin-shaped, and the mixing bodies 37′ are arc-shaped. Together, the mixing bodies 37 and 37′ form a complex geometry that ensures a particularly good mixing of the curable mass.

1.-6. (canceled)

7. A method for installing an anchor for fastening of an attachment part to a base part, comprising the steps of:
disposing an anchor bolt of the anchor in a hole defined by the base part and in a through hole defined by the attachment part;
disposing a damper sleeve on the anchor bolt such that the damper sleeve surrounds the anchor bolt; and
adhesively bonding the damper sleeve to the attachment part by an adhesive.

8. The method according to claim 7, wherein an adhesive reservoir is pressed between the damper sleeve and the attachment part and wherein the adhesive is extruded from the adhesive reservoir.

9. The method according to claim 8, wherein the adhesive reservoir is fixed to the damper sleeve to form a unit.

10. The method according to claim 7, wherein the adhesive is introduced into the through hole for a partial filling of the through hole.

11. A unit, comprising:
a damper sleeve; and
an adhesive reservoir fixed to the damper sleeve, wherein the adhesive reservoir contains adhesive.

12. A fastening set, comprising:
a unit, comprising:
a damper sleeve; and
an adhesive reservoir fixed to the damper sleeve, wherein the adhesive reservoir contains adhesive; and
an anchor with an anchor bolt, wherein the damper sleeve of the unit is configured for receiving and damping the anchor bolt.
